(19) United States
(12) Patent Application Publication
(10) Pub. No.: US 2026/0145310 A1
(43) Pub. Date: May 28, 2026

(54) PIN FASTENER REMOVAL TOOL

(71) Applicant: Richard Ward, Waverly, NY (US)

(72) Inventor: Richard Ward, Waverly, NY (US)

(21) Appl. No.: 19/397,026

(22) Filed: Nov. 21, 2025

Related U.S. Application Data
(60) Provisional application No. 63/724,459, filed on Nov. 25, 2024.

(51) Int. Cl. B25B 27/20; B25B 27/00; B60D 1/52

(52) U.S. Cl. CPC B25B 27/20; B25B 27/0035; B60D 1/52

(57) ABSTRACT

A pin fastener removal tool, having a member having a first curved section, a second curved section, and a third curved section between a first free end and a second free end, and the second curved section between the first curved section and the third curved section; the first curved section and the third curved section curved in the same direction and in the opposite direction to the second curved section; and the second curved section is configured for engagement with a pin fastener.

### CROSS-REFERENCE TO RELATED APPLICATIONS

This application claims priority under 35 U.S.C. § 119 to U.S. Provisional Application No. 63/724,459, filed on Nov. 25, 2024, which is herein incorporated by reference in its entirety.

### BACKGROUND OF THE INVENTION

### Technical Field

The invention is generally related to devices, systems, and methods for removing various pin fasteners, pins, and clips, and particularly devices, systems, and methods for removing pin fasteners, pins, and clips from trailer hitches such as those used to tow a trailer from the rear of a vehicle, and various other common mechanical devices.

### Background Information

Pin fasteners, such as hitch pins, hitch clips, lynchpins, r-clips, bridge pins, hairpin cotters, spring cotters, ring cotter pins, lock pins, safety pins, cotter pins, and similar fasteners and their variants are generally used to align and keep one or more components from separating or decoupling. A pin fastener may be placed around, through, and/or into a pin, where the pin is used to keep two or more components together. A pin fastener may also be used to fasten two or more components together by inserting the pin fastener through aligned holes in each component such that the pin fastener is not easily removable, and the pin fastener generally remains in place keeping the two components from separating or decoupling. Other variants of devices which use a pin fastener exist, with the pin fastener placed to prevent two or more components from separating or decoupling. Often such pin fasteners may be put in difficult to reach spaces where using hands alone or using traditional tools like pliers is difficult, making pin fastener removal difficult.

A common application for pin fasteners is in the fastening mechanism for a towing hitch. Many vehicles are equipped to tow a trailer from the rear of the vehicle. Such vehicles generally have a receiver attached to a portion of the vehicle's frame. The receiver is configured (e.g., shaped and dimensioned) to receive a draw bar connected to a hitch ball. The draw bar and the receiver may have a hole through them, with the draw bar inserted into the receiver such that their respective holes are aligned. A trailer pin inserted through the draw bar and receiver holes, prevents the draw bar and receiver from separating. The trailer pin itself has a hole through it, into which a pin fastener, such as a hitch clip, is inserted. The hitch clip remains in place, preventing the trailer pin from sliding out and keeping the drawbar in the receiver. However, removing the hitch clip by hand can be difficult and often requires a considerable amount of force applied within a confined space. The person removing the hitch clip often ends up with cuts and bruises on their pulling hand. Because of the confined or tight space, existing tools such as pliers, screwdrivers, or other existing tools cannot be easily used or may still result in cuts and bruises on a person's hand.

What is needed is a tool to help remove pin fasteners in tight spaces, without hurting a person's hand.

### SUMMARY OF THE INVENTION

The present disclosure is directed toward devices, systems, and methods for removing pin fasteners.

A pin fastener removal tool, having a member having a first curved section, a second curved section, and a third curved section between a first free end and a second free end, and the second curved section between the first curved section and the third curved section; the first curved section and the third curved section curved in the same direction and in the opposite direction to the second curved section; and the second curved section is configured for engagement with a pin fastener.

These and other objects, features, and advantages of this disclosure will become apparent from the following detailed description of the various aspects of the disclosure taken in conjunction with the accompanying drawings.

### BRIEF DESCRIPTION OF THE DRAWINGS

FIG. 1 depicts components of a trailer hitch;

FIG. 2 depicts a hitch pin and retaining clip;

FIG. 3 depicts the assembled trailer hitch of FIG. 1 connected with the hitch pin of FIG. 2;

FIG. 4 depicts a clip puller in accordance with one or more embodiments set forth herein;

FIG. 5 depicts a second embodiment of the clip puller of FIG. 4, in accordance with one or more embodiments set forth herein;

FIG. 6 depicts the clip puller of FIG. 4 engaged with the hitch pin of FIG. 2, in accordance with one or more embodiments set forth herein;

FIG. 7 depicts the clip puller of FIG. 4 engaged with the hitch pin of FIG. 2, and the assembled trailer hitch of FIG. 1, in accordance with one or more embodiments set forth herein;

FIG. 8 depicts the clip puller of FIG. 4 engaged with the hitch pin of FIG. 2, in accordance with one or more embodiments set forth herein; and

FIG. 9 is a perspective view of clip puller of FIG. 4 attached to the hitch pin of FIG. 2, in accordance with one or more embodiments set forth herein.

### DETAILED DESCRIPTION OF THE INVENTION

Aspects of the present disclosure and certain embodiment, features, advantages, and details thereof, are explained more fully below with reference to the non-limiting examples illustrated in the accompanying drawings. Descriptions of well-known materials, fabrication tools, processing techniques, etc., are omitted so as not to unnecessarily obscure the relevant details. It should be understood, however, that the detailed description and the specific examples, while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art from this disclosure. Furthermore, although certain methods are described with reference to certain steps that are presented herein in a certain order, in many instances, these steps may be performed in any order as may be appreciated by one having ordinary skill in the art, and the methods are not limited to the particular arrangement of steps disclosed herein.

Approximating language, as used herein throughout disclosure, may be applied to modify any quantitative representation that could permissibly vary without resulting in a change in the basic function to which it is related. Accordingly, a value modified by a term or terms, such as “about” or “substantially,” is not limited to the precise value specified. In some instances, the approximating language may correspond to the precision of an instrument for measuring the value.

Terminology used herein is for the purpose of describing particular examples only and is not intended to be limiting. As used herein, the singular forms “a”, “an” and “the” are intended to include the plural forms as well, unless the context clearly indicates otherwise. Furthermore, references to “one embodiment” are not intended to be interpreted as excluding the existence of additional embodiments that also incorporate the recited features. Moreover, unless explicitly stated to the contrary, the terms “comprising” (and any form of “comprise,” such as “comprises” and “comprising”), “have” (and any form of “have,” such as “has” and “having”), “include” (and any form of “include,” such as “includes” and “including”), and “contain” (and any form of “contain,” such as “contains” and “containing”) are used as open-ended linking verbs. As a result, any embodiments that “comprises,” “has,” “includes” or “contains” one or more step or element possesses such one or more step or element, but is not limited to possessing only such one or more step or element. As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances, an event or capacity can be expected, while in other circumstances the event or capacity cannot occur—this distinction is captured by the terms “may” and “may be.”

As used herein, the term “portion” is not limited to a single continuous body of material unless otherwise noted. A “portion” may include multiple sub-portions that may be the same or differing materials, and/or may include coatings, adhesives, and the like, and may be a separate and distinct component or may be an integral section, segment, or fragment of a larger component. As used herein, the term “coupled” is not limited to a direct coupling of two separate and distinct components. Two “coupled portions” may include indirectly coupled portions or directly coupled portions.

The term “pin fastener” may include, for example, hitch pins, bridge pins, hitch clips, lynchpins, r-clips, hairpin cotters, spring cotters, ring cotter pins, lock pins, safety pins, cotter pins, and other similar fasteners or their variants. Generally, pin fasteners have at least one elongated section connected to an eye or a circular section or a ring. Pin fasteners are commonly available fasteners, clips, or retaining devices. The term fastener is used throughout, however it is understood, that there may be some play between the attached or coupled components, and most pin fasteners are used to retain or maintain coupling between two or more components.

An application of pin fasteners is to hold a first component and a second component together where the two components are configured (e.g., shaped and dimensioned) such that the first component may be inserted in or through the second component. The two components may have a hole through them and the two components may be aligned and fastened or coupled together by inserting the pin fastener through the hole such that the pin fastener is not easily removable. In another application, the two components may be aligned and the pin fastener placed over one of the components, using spring tension to remain attached or coupled. In both examples the pin fastener remains in place keeping the two components from separating. A pin fastener may also be placed through or into a pin, where the pin is used to keep two or more components together and the pin fastener prevents the pin from sliding out or being easily removed. These three uses of pin fasteners are provided as examples, however the use of pin fasteners is well known and there may be other applications or uses of pin fasteners.

The invention will be better understood by reference to the figures where like reference numbers refer to like components, and like reference numerals are used to indicate like or analogous components throughout the several views.

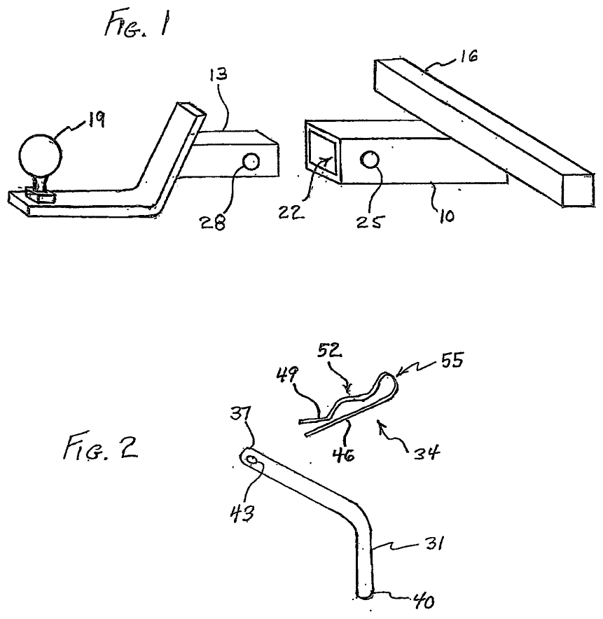

Many vehicles are equipped to tow a trailer from the rear of the vehicle. Such trailers are commonly used to carry a boat, a camper, or lawn maintenance equipment. With reference to FIG. 1, a common device used to attach the trailer to the vehicle is depicted in a disassembled state. A receiver 10 is attached to a portion of a vehicle frame 16 (vehicle not shown), and receiver 10 has an opening 22 to a hollow interior. Receiver 10 further has a hole 25 extending through a sidewall of the body of receiver 10 and through an opposite sidewall (not shown). A drawbar 13 is depicted having a hitch ball 19 and a hole 28 extending through a sidewall of the body of the drawbar 13 and through an opposite sidewall. Drawbar 13 and receiver 10 are configured (e.g., shaped and dimensioned) such that drawbar 13 may be inserted into receiver 10 into opening 22 so that a portion of drawbar 13 resides inside receiver 10 and hole 25 and hole 28 are aligned forming an axial pathway through drawbar 13 and receiver 10.

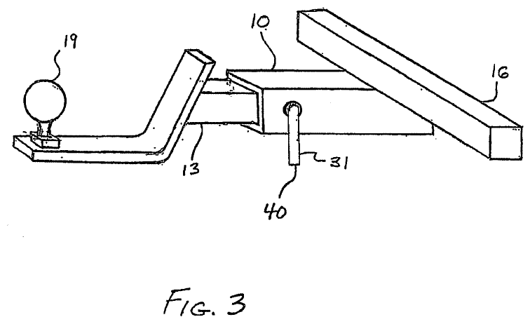

FIG. 2 depicts a pin 31 extending from a first end 37 to a second end 40 forming a body and a hole 43 extending through the body. Pins such as pin 31 are often cylindrical and hole 43 extends through the body towards first end 37. Pin 31 is depicted as L-shaped or angled towards second end 40. Also depicted is a hitch clip 34. Alternate configurations of pin 31 may be straight rather than angled but may include a flange at end 40. Pin 31 need not be cylindrical.

Clip 34 often has a straight first portion 46, a curved second portion 49, and an eye or looped end 55. Clip 34 is commonly made of a resilient material, such as steel or a metal alloy. Clip 34 depicts a hitch clip, however other types of pin fasteners may be used.

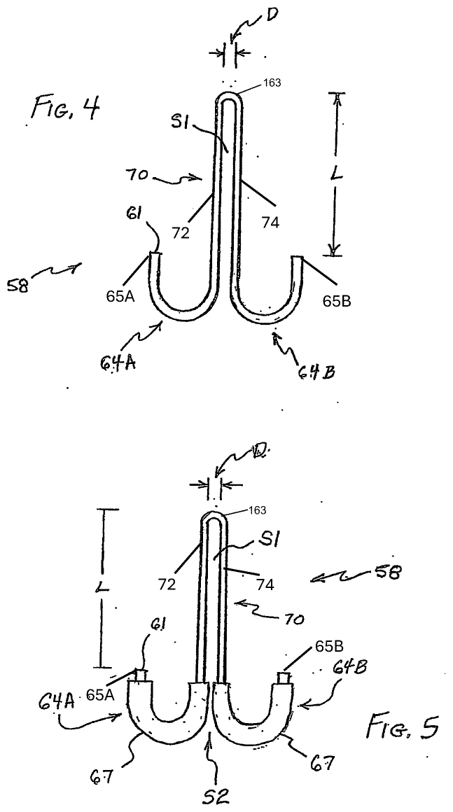

With reference to FIG. 3, pin 31 is depicted as inserted into and through hole 25 and hole 28 (not shown).

With reference to FIGS. 1-3 , to fix the position of drawbar 13 relative to receiver 10, hole 25 and hole 28 are aligned. The first end 37 of pin 31 is inserted through hole 25 of receiver 10 and hole 28 of drawbar 13 until the hole 43 in pin 31 extends beyond the opposite sidewall of receiver 10 (see e.g., FIG. 7). Next, the straight portion 46 of clip 34 is inserted through hole 43 in pin 31 until a middle portion 52 of clip 34 contacts pin 31. In this position, the middle portion 52 of clip 34 is tight against pin 31 so that clip 34 is not easily removed from pin 31. With reference to FIG. 3 and FIG. 7, the angled section of pin 31 is inhibited from passing through hole 25 and hole 28. Clip 34 prevents pin 31 from leaving receiver 10 and drawbar 13. The combination of pin 31 and clip 34 fix the position of receiver 10 relative to the drawbar 13 and inhibit pin 31 from being easily removed.

With the relative position of receiver 10 and drawbar 13 fixed a trailer may be attached to the hitch ball 19. Once attached to the hitch ball 19, the trailer may be towed by the vehicle. Once towing is finished, the trailer may be disengaged from hitch ball 19.

To remove the drawbar 13 from receiver 10, pin 31 is removed, and in order to remove pin 31, clip 34 is removed. Clip 34 may be removed by pulling on the portion at eye 55 (see FIG. 2). However, a significant amount of force is often needed to remove clip 34 from pin 31. Furthermore, pin 31 may be short and the space between the clip 34 and receiver 10 may be small.

With continued reference to FIGS. 1-3, and FIG. 7, pin 31 may be sized to minimize lateral movement and free play between hole 43 and the angled section of pin 31 when engaged in hole 25 and hole 28. Thus pin 31 is sized such that the angled section is close to the sidewall of receiver 10 and hole 43 is generally positioned close to the opposite sidewall of receiver 10, such that clip 34 is installed close to receiver 10. Clip 34 is configured (e.g., shaped and dimensioned) such that some force is required in order to remove clip 34. To remove clip 34, a person pulls on eye 55 with one of his/her fingers or using pliers, exerting enough force so that clip 34 flexes enough to move the middle portion 52 away from pin 31. When clip 34 moves over pin 31, clip 34 is quickly released from pin 31. Because of the force needed, the person pulling clip 34 often cannot stop pulling quickly enough to avoid a collision between the person's pulling hand and portions of the vehicle, receiver 10, or drawbar 13. Such impact commonly results in cuts and bruises to the pulling-hand.

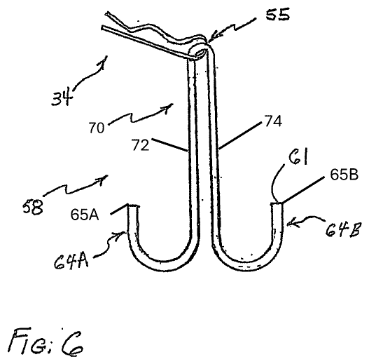

Depicted in FIG. 4 is a tool 58. Tool 58 may be referred to as a pin fastener removal tool, a clip puller, or a pin clip puller. Tool 58 is formed from member 61 having a first curved section 64A, a second curved section 70, and a third curved section 64B between a first free end 65A and a second free end 65B. Second curved section 70 has a first elongated section or a first arm 72 between first curved section 64A and a curved engagement section 163 and a second elongated section or a second arm 74 between curved engagement section 163 and third curved section 64B. First curved section 64A and third curved section 64B are curved in the same direction. Second curved section 70 is between first curved section 64A and third curved section 64B, with second curved section 70 connected to and curved in the opposite direction to first curved section 64A and second curved section 64B. First curved section 64A, second curved section 70, and third curved section 64B may, for example, form a continues member 61 having a sinusoidal shape or “W” shape. There is a distance D between first arm 72 and second arm 74, forming space S1 between.

First curved section 64A and third curved section 64B are configured (e.g., shaped and dimensioned) to accommodate human digits on, for example, a concave part of first curved section 64A and third curved section 64B. In this particular embodiment, first curved section 64A and third curved section 64B are configured (e.g., shaped and dimensioned) to accommodate, for example, an index finger and a middle finger of a pulling-hand. First curved section 64A may be referred to as a first finger yoke and third curved section 64B may be referred to as a second finger yoke. Reference to first finger yoke and second finger yoke is made because first curved section 64A and second curved section 64B may, for example, accommodate fingers and have a force applied by a person's fingers, acting as yokes for tool 58. An index and middle finger are described but other fingers may be used with tool 58 or fingers on different hands may be used with tool 58.

FIG. 5 depicts tool 58 having a coating on first finger yoke (e.g., first curved section 64A) and second finger yoke (e.g., third curved section 64B). A portion of first finger yoke (e.g., first curved section 64A) and second finger yoke (e.g., third curved section 64B) may be coated with a flexible material 67, such as, for example, a plastic material, rubber, PVC or some other similar material. Flexible material may, for example, coat first finger yoke (e.g., first curved section 64A) and second finger yoke (e.g., third curved section 64B) entirely or such that there is coverage to accommodate the size of fingers placed against concave portions of the first finger yoke (e.g., first curved section 64A) and second finger yoke (e.g., third curved section 64B). The flexible material 67 may, for example, increase the surface area that is in contact with each of the digits grasping pulling fingers, reducing the force-per-unit-area in order to avoid injury to those portions of the fingers that contact tool 58. Also, the flexible material 67 may, for example, be of a type to thermally insulate the pulling fingers from member 61 and help with grasping tool 58 in cold or hot environments. In certain other embodiments, the flexible material may coat a portion of or the entire member 61.

With reference to FIG. 7, an assembled trailer hitch is depicted. Tool 58 is shown inserted into clip 34 which is inserted into pin 31. Tool 58 is engaged with clip 34 at engagement section 163. Pin 31 is engaged with the receiver 10 and the drawbar 13. The receiver is shown connected to a portion of the vehicle frame 16.

With reference to FIGS. 4-9, second curved section 70 may be, for example, used to engage clip 34, such that member 61 may be passed through eye 55 and clip 34 may pass into S1, such that engagement section 163 may be in contact with the surface of clip 34 within eye 55. In embodiments with flexible material 67, second curved section 70 may be, for example, used to engage clip 34, such that member 61 may be passed through eye 55 and clip 34 may pass through space S2 and into S1, such that engagement section 163 may be in contact with the surface of clip 34 within eye 55.

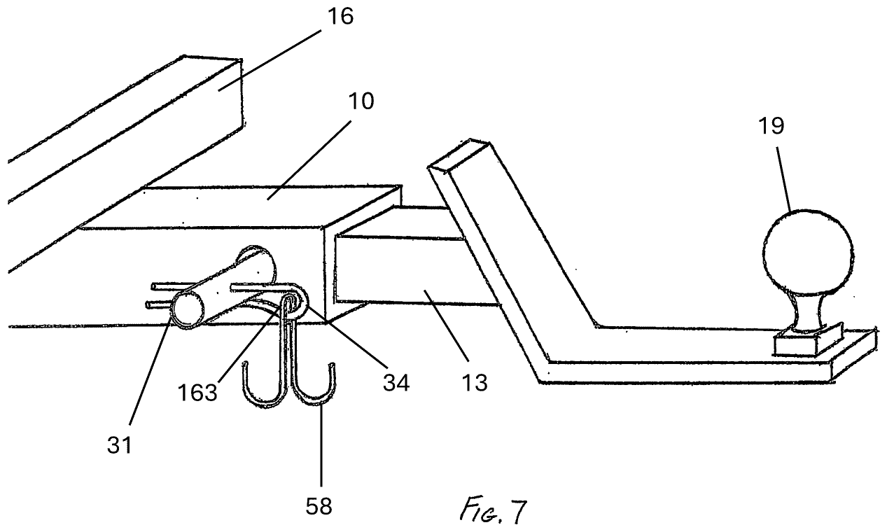

FIG. 6 depicts tool 58, engaged with clip 34. Referring to FIGS. 5 and 6, The length L of first arm 72 and second arm 74 may be significantly greater than the distance D between them. For example, the length L may be three or more times the distance D. By having such an elongated second curved section 70, the first finger yoke (e.g., first curved section 64A) and the second finger yoke (e.g., third curved section 64B) may be distanced from clip 34, receiver 10, and drawbar 13 when tool 58 is engaged with clip 34.

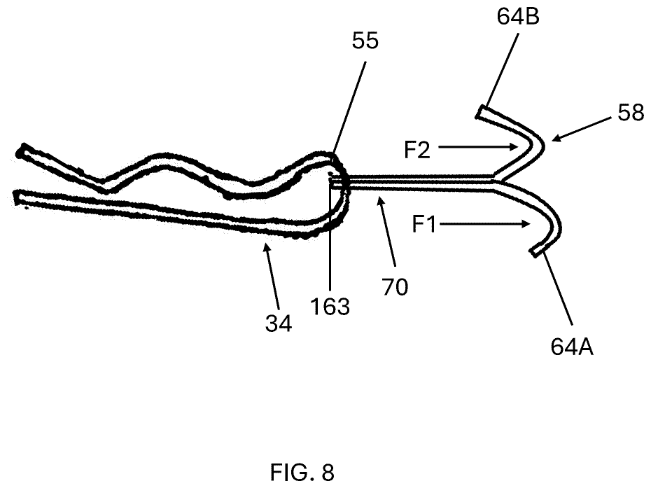

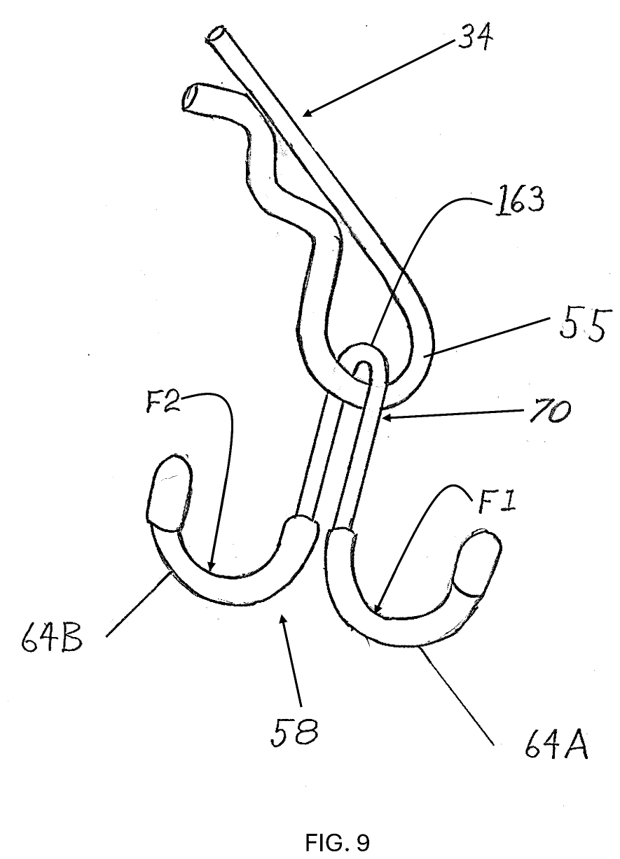

Referring to FIGS. 8 and 9, tool 58 is show with second curved section 70 around clip 34 and through eye 55. The engagement section 163 of tool 58 is also depicted. First curved section 64A, third curved section 64B, are depicted with a force F1 and a force F2 directed towards them. With reference to FIG. 8, by placing a first finger (not shown) onto the concave portion of first finger yoke (e.g., first curved section 64A) and a second finger (not shown) on the concave portion of second finger yoke (e.g., third curved section 64B), and applying force F1 and force F2 to the yokes respectively, a concave portion of engagement section 163 contacts clip 34 at the eye section 55 and provides a pulling force on clip 34. With sufficient force, clip 34 can be pulled out from pin 31 (see FIG. 7).

With reference to FIG. 7, tool 58 allows for some distance to be created between the hand of the person attempting to remove clip 34 and components of the hitch, such as the receiver 10 and the drawbar 13. When clip 34 releases from pin 31, the pulling-hand is less likely to strike the hitch components.

Referring to FIGS. 4-7, the length L and distance D may be such that tool 58 may remain engaged with clip 34 during towing. By making the length L of the second curved section 70 long relative to the distance D between the member 61 portions that form second curved section 70, tool 58 is inhibited from disengaging from clip 34 during towing. More specifically, in order to disengage tool 58 from clip 34, the wire of clip 34 would have to move through space S1 between the first arm 72 and second arm 74 forming second curved section 70, and sliding first curved section 64A or second curved section 64B through the eye 55. It is unlikely that vibrations or debris striking the tool 58 during towing may occur, making it unlikely that tool 58 will become disengaged from clip 34 without human intervention. Thus tool 58 need not be removed from eye 55 of clip 34 after engagement, and thus tool 58 may be available to remove clip 34, when desired. In embodiments where flexible material 67 is coating portions of first curved section 64A or second curved section 64B, space S2 may be, for example, narrower than S1 further inhibiting undesired removal of tool 58 from clip 34. Furthermore, the space S2 between the flexible material 67 may be sufficiently small such that tool 58 must be flexed in order to pass clip 34 between the flexible material 67, thereby further inhibiting tool 58 from becoming disengaged from clip 34 without human intervention. As long as clip 34 is engaged with pin 31, tool 58 is prevented from sliding off an open end of clip 34.

Referring to FIGS. 4-7, in certain embodiments, first arm 72 and second arm 74 may be angled from engagement section 163 toward first curved section 64A and third curved section 64B respectively. Thus, space S1 may be, for example, wider near engagement section 163 and narrower towards first curved section 64A and third curved section 64B.

An elongated second curved section 70 may, for example, be useful for removing hitch clips or pin fasteners placed in similarly tight spaces. However, the first curved section 64A, second curved section 70, and third curved section 64B, may have similar curvatures in some embodiments. With reference to FIGS. 4 and 5, D and L may, for example, be such that L is less than 3 times D.

Installation of tool 58 may, for example, include: pushing one of the finger yokes (e.g., first curved section 64A and third curved section 64B) through eye 55 of clip 34; and moving tool 58 such that second curved section 70 is passed over the clip wire and into space S1, to engage with engagement section 163. Engagement section 163 may, for example, rest on the wire forming eye 55, and tool 58 may hang from clip 34.

Referring to FIGS. 7-9, tool 58 may, for example, minimize injury to a person's pulling-hand by distancing the pulling-hand from receiver 10 and drawbar 13. Removing clip 34 from pin 31 using tool 58 may, for example, include: engaging one finger with first finger yoke (e.g., first curved section 64A) and a second finger with second finger yoke (e.g., second curved section 64B); pulling tool 58 by first finger yoke (e.g., first curved section 64A) and second finger yoke (e.g., second curved section 64B); providing sufficient force (e.g., force F1 and force F2) to cause clip 34 to flex and slide away from pin 31.

The length L of the second curved section 70 provides distance between the pulling-hand and receiver 10 or drawbar 13 to minimize a collision with the hand when clip 34 releases. As a result, the pulling-hand can apply greater pulling force, while remaining safely away from receiver 10 and drawbar 13. The ability to apply greater pulling force while remaining safely distanced makes removing a hitch clip 34 safer, easier, and simpler.

Tool 58 may, for example, have member 61 formed of a material such as steel, stainless steel, a metal alloy, plastic, or some similar rigid and durable material such that when tool 58 is engaged with clip 34 by second curved section 70, and a force is applied to the first finger yoke (e.g., first curved section 64A) and the second finger yoke (e.g., third curved section 64B), the material will resist bending or breaking while removing clip 34.

While several aspects of the present invention have been described and depicted herein, alternative aspects may be effected by those skilled in the art to accomplish the same objectives. While tool 58 has been described for engagement and removal of hitch clips, one skilled in the art would understand that tool 58 may be, for example, used to engage with and remove a variety of other pin fasteners, including bridge pins, hitch clips, lynchpins, r-clips, hairpin cotters, spring cotters, ring cotter pins, lock pins, safety pins, cotter pins, and similar fasteners and their variants. Tool 58 has been described as having finger yokes (e.g., first curved section 64A and third curved section 64B) to each accommodate a digit, and in particular an index and middle finger. However, for certain pin fastener removal applications, the finger yokes may, for example, be configured (e.g., shaped and dimensioned) to accommodate more than one finger, or even one or more fingers on more than one hand. Thus, one skilled in the art would understand. Accordingly, it is intended by the appended claims to cover all such alternative aspects as fall within the true spirit and scope of the invention.

What is claimed is:

1. A pin fastener removal tool, comprising:
a member having a first curved section, a second curved section, and a third curved section between a first free end and a second free end, the second curved section between the first curved section and the third curved section;
the first curved section and the third curved section curved in the same direction and curved in an opposable direction to the second curved section; and
the second curved section is configured for engagement with a pin fastener.

2. The pin fastener removal tool of claim 1, wherein the first curved section is configured to accommodate a first digit, and the third curved section is configured to accommodate a second digit.

3. The pin fastener removal tool of claim 1, wherein the member further comprises:
a first arm connected to and between the first curved section and the second curved section;
a second arm connected to and between the third curved section and the second curved section;
and the length of the first arm and the second arm being at least three times the distance between the first arm and the second arm.

4. The pin fastener removal tool of claim 3, wherein the distance between the first arm and the second is sized to accommodate the pin fastener.

5. The pin fastener removal tool of claim 1, further comprising a flexible material coating.

6. The pin fastener removal tool of claim 1, wherein the pin fastener removal tool is configured to be threaded through an eye of the pin fastener, and the second curved section is configured for engagement with the eye of the pin fastener.

7. The pin fastener removal tool of claim 1, wherein the member comprises a material wherein the first curved section, the second curved section, and the third curved section are inhibited from bending under a force applied sufficient to remove a pin fastener.

8. The pin fastener removal tool of claim 5, wherein the flexible material coating is selected from the group consisting of plastic, rubber, and combinations thereof.

9. The pin fastener removal tool of claim 7, wherein the material is selected from the group consisting of steel, stainless steel, a metal alloy, plastic, and combinations thereof.

10. The pin fastener removal tool of claim 4, wherein from the second curved section, the first arm and the second arm angle towards each other.

11. The pin fastener removal tool of claim 1, wherein the member is continuous between the first free end and the second free end.

12. The pin fastener removal tool of claim 1, wherein the member is a ‘W’ shape.

13. The pin fastener removal tool of claim 8, wherein the flexible material coating is a thermally insulating material.

14. The pin fastener removal tool of claim 8, wherein the first curved section and the third curved section of the member are coated in the flexible material.

15. The pin fastener removal tool of claim 1, wherein the first curved section and the third curved section are each configured to accommodate more than one digit.
